(19) United States
(12) Patent Application Publication
(10) Pub. No.: US 2008/0105536 A1
(43) Pub. Date: May 8, 2008

(54) Method For Producing Elemental Halides

(75) Inventor: Norbert Auner, Glashutten (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/719,043

(22) PCT Filed: Nov. 10, 2005
(86) PCT No.: PCT/EP05/12052

§ 371 Date: May 10, 2007

(30) Foreign Application Priority Data
Nov. 18, 2004 (DE) 10 2004 055 687.3
May 25, 2005 (DE) 10 2005 024 104.2

(51) Int. Cl. C01B 7/00; C01B 33/00

(52) U.S. Cl. 204/157.43; 204/157.48; 204/157.45

(57) ABSTRACT

Element halides are prepared in high yield by contacting an element or compound thereof and carbon or a carbon source with a gas stream containing a halogen or halogen compound in the gaseous state, and heating by means of an alternating magnetic field.

A process for preparing element halides which is characterized in that a mixture of a material containing the respective element and carbon or a carbon-containing material is prepared in a first step and this mixture is brought into contact with a halogen which is gaseous under the reaction conditions selected, hydrogen halide or a mixture thereof and heated, with the energy being introduced by means of an electromagnetic alternating field, is described.

Element halides are compounds of elements with the halogens fluorine, chlorine, bromine, iodine or mixtures of these halogens. The element-halogen compound can have an ionogenic character, for example a halogen-alkali metal bond, e.g. NaCl, or a predominantly covalent character as in the case of metal-halogen bonds, e.g. SiCl₄, or nonmetal-halogen bonds, e.g. PCl₃.

Element halides are used in a wide variety of ways in industry. Some elements such as aluminum, titanium, boron or silicon are obtained from element halides. In the case of some elements, a halogenating oxidation and a subsequent dehalogenating reduction is employed to prepare these elements in particularly high purity. If appropriate, the element-halogen compounds can in this case be additionally purified by sublimation, for example in the case of AlCl₃, or distillation, for example in the case of TiCl₄. The dehalogenation can, for example, be effected by means of hydrogen, for example in the case of BCl₃, or by thermal decomposition, for example the decomposition of BBr₃ on tungsten wire. This also makes element halides important starting materials for CVD or similar processes. Furthermore, element halides are basic building blocks for, for example, industrially and synthetically important catalysts, for example Friedel-Crafts catalysts for electrophilic substitution of aromatics, alkylation, acylation, or Ziegler-Natta catalysts for polymerizations, for the formation of element-element bonds, for example by means of Wurtz coupling reactions, Grignard reactions, salt metathesis to form element-oxygen, element-phosphorus, element-nitrogen, element-boron, element-sulfur bonds, and intermediates and auxiliaries, for example AlCl₃ in pharmaceuticals, cosmetics, textiles or as flocculant in water treatment. As industrially particularly important element halides, mention may be made of tetrachlorotitanium and tetrachlorosilane as intermediates for titanium dioxide production and the production of finely divided silica.

Various processes for preparing element halides are known from the prior art, and these can be classified into a number of groups.

All known element halides can be produced by reaction of the elements with the respective halogen, if appropriate with heating. In the case of some elements, a reaction with hydrogen halide in which hydrogen is generally also liberated is also known. In this reducing atmosphere, the element halides are usually obtained in a comparatively low oxidation state. To obtain element halides in a higher oxidation state, it is in some cases possible to react the elements with halogen instead of hydrogen halide or subsequently to oxidize the lower element halides by means of halogen, in particular chlorine. It is also possible to convert element halides in a high oxidation state into a lower oxidation state by means of hydrogen or similar reagents which reductively remove halogen.

Examples of such reactions are:

Fe+2 HCl→FeCl₂+H₂

2 Fe+3 Cl₂→2 FeCl₃

PCl₃+Cl₂→PCl₅

2 BCl₃+“chlorine-removing reagent”→B₂Cl₄

In the latter equation, the chlorine-removing reagent can be copper or mercury.

A further known process is carbochlorination. The term “carbochlorination” is used to describe a reaction of preferably element oxides with carbon and chlorine with introduction of thermal energy. In the case of some elements, carbochlorination by means of hydrogen chloride is also known.

Such reactions are described, for example, in the patent texts JP 62-143813 A2 and U.S. Pat. No. 4,576,812:

TiO₂+2 Cl₂+2 C→TiCl₄+2 CO

Al₂O₃+3 Cl₂+3 C→2 AlCl₃+3 CO

BaSO₄+C+Cl₂→BaCl₂+CO₂+SO₂

A process similar to carbochlorination is chlorinating roasting. In chlorinating roasting, element compounds are mixed with chlorine-containing compounds and heated, if appropriate in the presence of carbon or carbon-containing compounds. Chlorine-containing compounds used are, for example, tetrachlorosilane or tetrachloromethane, sodium chloride or chlorine-containing sulfur compounds such as thionyl chloride and sulfuryl chloride.

Thus, according to H. F. Johnstone et al., in Ind. engg. Chem. 34 (1942) 280, mixtures of chromite with sodium chloride or potassium chloride can be reacted with a sulfur dioxide/air mixture to give water-soluble chlorides and sulfates. Rauter (Liebigs Ann. 270, 1892, 236) describes the reaction of cadmium oxide with silicon tetrachloride to give cadmium chloride:

2 Cdo+SiCl₄→2 CdCl₂+SiO₂.

Likewise, cadmium chloride can be obtained from cadmium oxide according to:

CdO+SOCl₂→CdCl₂+SO₂

by means of the process described by North and Hagemann in J. Am. Chem. Soc. 35 (1913) 2088. The patent texts U.S. Pat. No. 2,895,796 and U.S. Pat. No. 3,652,219 disclose, for example, a process for preparing iron(II) chloride from iron sulfide according to:

FeS₂+SCl₂→FeCl₂+3 S.

Furthermore, the patent texts U.S. Pat. No. 4,209,501 and U.S. Pat. No. 4,576,812, for example, describe a process for preparing iron(II) chloride from iron(III) chloride according to:

ZnS+2 FeCl₃+ZnCl₂+2 FeCl₂+S.

Finally, mention may be made of the direct reaction of element compounds with hydrogen halides to form element halides and liberate hydrogen compounds as in the following examples:

SiO₂+4 HF→SiF₄+2H₂O,

As₂O₃+HCl→AsCl₃+H₂O and

SnS+2 HCl→SnCl₂+H₂S.

Various embodiments for preparing element halides are known in the prior art. A process which is frequently employed in a comparable way and is described, for example, in the patent text U.S. Pat. No. 4,083,923 converts starting compounds which are solid under the reaction conditions into element halides which are gaseous under the reaction conditions; a process disclosed, for example, in the patent text U.S. Pat. No. 4,576,812 obtains element halides which are solid under the reaction conditions from solid starting materials. Processes in which the reaction of the starting compounds takes place in the liquid phase or a suspension, for instance in a salt melt, are also known. A process disclosed, for example, in the patent text U.S. Pat. No. 4,039,648 leads to element halides which are gaseous under the reaction conditions, while processes described, for example, in the patent texts U.S. Pat. No. 4,209,501 or U.S. Pat. No. 4,597,840 produce products dissolved in the liquid phase.

The prior art also describes reactions of mixtures of different element compounds, for example aluminas or bauxite, to form mixtures of element halides which can subsequently be purified by fractional condensation, filtration or distillation. In addition, the patent texts U.S. Pat. No. 3,935,297, U.S. Pat. No. 4,083,923 and WO 2004/063096, for example, disclose processes which offer the opportunity of removing impurities in the desired target product by selective reaction.

Some of the processes described in the prior art which do not start out from the elements have the disadvantage that they convert only a small proportion of the element present into element halides. To increase the yields or to improve the reaction rate, use is often made of catalysts as described, for example, in the patent texts U.S. Pat. No. 1,565,220 with addition of sulfur in the carbochlorination of alumina to accelerate the reaction and U.S. Pat. No. 4,083,927 with addition of BCl₃ in the carbochlorination of kaolin-containing raw materials in order to accelerate the reaction to form AlCl₃ compared to that to form SiCl₄. Furthermore, by-products which are of concern in terms of occupational hygiene and environmental toxicity are formed in some of these processes. Thus, the carbochlorination of element oxides by means of chlorine gas can produce dichloroketone (phosgene) . To minimize the liberation of phosgene, the chlorine gas used has to be reacted as completely as possible in the reactor, as described, for example, in the patent texts JP 60-112610 A2 and JP 60-118623 A2:

SiO₂+2C+2Cl₂→SiCl₄+2CO

CO+Cl₂→COCl₂

It is an object of the present invention to provide a process for preparing element halides which is particularly versatile in terms of the starting materials used and proceeds without addition of catalysts.

This object is achieved according to the invention by a process for preparing element halide, characterized in that a mixture of a material containing the element with carbon or a carbon-containing material is brought into contact with a gas stream containing halogen which is gaseous under the reaction conditions or a gaseous halogen compound or a mixture thereof while heating by means of the action of an electromagnetic alternating field.

According to the invention, it has been found that when an electromagnetic alternating field, preferably microwave radiation, is used as energy source for carrying out the process of the invention, it is possible to employ any compounds containing the element, with the process of the invention not being subject to any restrictions either in respect of the type of material containing the element which is used or in respect of the specific surface area of this material. There are barely any restrictions in respect of the type and specific surface area of the carbon or carbon-containing material used either. The carbon or carbon-containing material used has to be present in a form which is suitable for converting electromagnetic waves into thermal energy, i.e. is capable of being thermally excited by electromagnetic alternating fields.

No catalyst is necessary for carrying out the process of the invention, while this is often necessary in the prior art.

The process of the present invention makes no demands on the element-containing and carbon-containing material used. However, preference is given to using element oxides or element sulfides and also mixtures of these oxides or sulfides with contaminating compounds, in particular ones having a very high element content. As nonlimiting examples of mixtures which can be utilized, mention may be made of titanium-containing waste materials from titanium dioxide production, silicon-containing waste materials such as rice ash and carbon-containing residues from combustion or pyrolysis processes. These materials are at present problem materials which have to be disposed of in a landfill with all the associated problems and costs. Recycling of glasses, the product of digestion of aluminum-containing silicates or mixtures of aluminum oxides with silicon oxide and iron oxides, for example bauxite, is also possible.

Some suitable starting materials are shown in Table 1.

TABLE 1

| Element | Source |
|---|---|
| Fe | Fe₂O₃, FeO, Fe₃O₄, iron ores |
| Ti | TiO₂, ilmenite |
| Si | Desert sand, quartz, mica, rice ash, fused |
| | silica, window glass, beer bottles, finely |
| | divided silica, silica sand, Duran glass, |
| | silicon carbide, silicon nitride |
| Al | Al₂O₃, bauxite |
| P | Ca₃(PO₄)₂ |
| B | B₂O₃ |
| Hf | HfO₂ |
| C | Activated carbon, hard coal, brown coal, |
| | petroleum coke |

The element halides can, if appropriate, be separated after the halogenation of the mixtures by known physical or chemical processes, for example by distillation of liquid or gaseous element halides, by sublimation of solid element halides or filtration to separate liquid or gaseous element halides from solid element halides.

A reaction of starting materials or mixtures thereof which contain the elements in particular ratios is also possible. In this way, it is possible, for example, to preset a doping ratio for a subsequent deposition process.

In the process of the invention, it is possible to prepare element halides which are liquid, gaseous or solid under the reaction conditions. The process is thus particularly versatile.

The process can be coupled with a deposition of the element halides by means of hydrogen. The hydrogen formed when using hydrogen halide for the halogenation can be used for this purpose.

The hydrogen liberated can alternatively be utilized for obtaining part of the energy required for the process. Compared to processes in which halogenation of the elements is carried out, energy and production costs can be saved by means of the single-stage process presented here. Production of the element is dispensed with. The process often formally proceeds without a change in the oxidation state of the element.

In the process of the invention, the carbon used or the carbon-containing material used can serve not only as heating element for thermal excitation by the electromagnetic alternating field, for example microwave radiation, but also as reducing reagent.

In a particularly preferred variant of the present invention, hydrogen chloride is used as halogen-containing compound. Apart from the avoidance of phosgene, hydrogen chloride is also technologically preferred because of its significantly lower boiling point compared to chlorine so that it can be separated more simply from the desired element halides. Hydrogen chloride is likewise advantageous in terms of reactor construction, since hydrogen chloride has a lesser oxidizing action on the reactor materials compared to chlorine.

The use of hydrogen halide for the reaction of, in particular, element oxides has the disadvantage that water is formed during the reaction because of the hydrogen bound to the halogen and this water can in turn hydrolyze a hydrolysis-sensitive element halide produced. In an embodiment of the process of the invention, the water gas equilibrium:

H₂O+C [symbol] CO+H₂

can be shifted in the direction of carbon monoxide and hydrogen by selection of a suitable temperature, preferably above 800° C., during the preparation of hydrolysis-sensitive element halides, for example tetrachlorotitanium. The water is withdrawn from the equilibrium and hydrolysis does not take place. The carbon monoxide/hydrogen mixture formed here can be utilized to produce energy or chemically.

The process of the invention is not subject to any restrictions either in respect of the type of material containing the element which is used or in respect of the specific surface area of this material. There are barely any restrictions in respect of the type and specific surface area of the carbon or carbon-containing material used either.

Starting materials which can easily be mixed industrially are preferably chosen for the process of the invention. These can, for example, be milling products of the materials containing the element and materials containing carbon, which are subjected to a milling process either separately or in premixed form. In a further embodiment, the constituents of the mixture or the mixture itself can be porous. Particular preference is given to the mixture having a pore volume which is large enough for the gaseous halogen or the gaseous halogen compound to penetrate through it so as to promote the reaction taking place. Compact materials having a low specific surface area, for example coarsely broken up natural minerals such as bauxite, ilmenite, quartz or sand, can also be reacted by means of the process of the invention.

The carbon used in the process of the invention or the corresponding carbon-containing material acts firstly as heating element within the mixture and secondly, if appropriate, also as reducing agent. Furthermore, the carbon used scavenges water by reduction to form hydrogen and in this way prevents water, which can, for example, be introduced via the starting materials or is liberated in the reaction, from having an adverse effect on the preparation of hydrolysis-sensitive element halides.

The element halide can be obtained virtually quantitatively. In the process of the invention, it is possible to use any compound containing the element.

In all embodiments of the process of the invention, it is possible to add catalysts to the reaction mixture in order to increase the reaction rates or improve the selectivity to the desired element halide, in particular when contaminated element-containing compounds are used in the process of the invention. The catalysts can be introduced into the reaction mixture before the latter enters the reactor, be fed in separately as solids, liquids or gases during the reaction or be introduced as gas in admixture with the hydrogen halide into the reaction space.

In a first embodiment of the process of the invention, the element-containing material is preferably used in the form of particles, for example powder, grains, spheres or granules, in order to allow the gaseous halogen or the gaseous halogen compound to be passed through readily.

A preferred molar ratio of element to carbon cannot be defined in generally valid terms since the process can be classified into a number of variants which require different minimum amounts of carbon to produce the desired element halide quantitatively:

1. reactions in which carbon does not act as reducing agent toward the element-containing compound; the carbon or the carbon-containing material is consumed only by reaction with impurities or with by-products of the halogenation and acts mainly as filler and as heating element. For this reason, mixing with the supplemented element-containing starting material has to be carried out every now and again in order to produce a homogeneous reaction mixture. The molar ratio of element to carbon is in this case preferably from 100:1 to 1:2.

2. carbon serves as reducing agent for pure element compounds; in this case, sufficient carbon to ensure stoichiometric reaction of the element has to be present. To enable heat to be generated continually, a stoichiometric excess is advantageous. The molar ratio of element to carbon is in this case preferably from 1:1 to 1:10.

3. carbon is used for the reduction of contaminated element compounds. In this case, it is not only necessary for sufficient carbon to produce the desired element halide to be present but, if complete reaction of the starting material is desired, the impurities also have to be able to be reacted quantitatively; a selective reaction is naturally likewise conceivable, in particular if catalysts are used for carrying out the process of the invention, for instance in a manner based on the patent text U.S. Pat. No. 4,083,927. In this third case, the molar ratio of carbon to all halide compounds produced is preferably from 10:1 to 1:1.

For the preparation of hydrolysis-sensitive element halides, the reaction temperatures are preferably greater than 700° C., particularly preferably greater than 800° C.

The halogen gas used is preferably chlorine. In a further embodiment of the process of the invention, hydrogen halide gas, preferably hydrogen chloride gas (HCl), is used as gaseous halogen compound. Hydrogen fluoride (HF) can likewise be used. The halogen-containing gas can be used in pure form or together with a carrier gas. As carrier gas, preference is given to CO₂ or inert gases selected from the group consisting of helium, nitrogen and argon and also mixtures thereof.

In a preferred embodiment, silicon tetrahalide is obtained virtually quantitatively. Virtually any SiOₓ source, where x is from 1 to 2, can be used in the process of the invention. It is advantageous to use SiO₂, but use of SiO and/or mixtures of the two is also possible. Suitable SiOₓ sources are, for example, sand such as desert sand or silica sand, glass, rice ash and silicates. It is therefore possible to use all materials which consist of SiOₓ or comprise SiOₓ, including appropriate silicates.

In a particularly preferred embodiment of the process of the invention, desert sand, for example, is used as suitable source of SiOₓ since it is available in large quantities. Such a desert sand generally has an SiO₂ content of greater than 80%.

Examples of compositions of desert sand are shown in Table 2 below (figures in %):

TABLE 2
Percentage composition of desert sand

Desert sand from
Abu Dhabi

| | White sand | Red sand |
|---|---|---|
| Fe₂O₃ | 0.32 | 1.21 |
| TiO₂ | 0.05 | 0.06 |
| CaO | 11.6 | 9.8 |
| K₂O | 0.91 | 1.12 |
| MgO | 1.08 | 3.40 |
| Na₂O | 0.59 | 0.51 |
| P₂O₅ | 0.05 | 0.02 |
| Al₂O₃ | 1.62 | 2.12 |
| SiO₂ | 83.8 | 81.8 |

SiOₓ or the SiOₓ-containing material is preferably used in the form of particles, for example powder, grains, spheres or granules, in order to allow good mixing and good passage of the gaseous halogen or the gaseous halogen compound.

The molar ratio of SiOₓ to carbon is preferably from 1:1 to 1:10, particularly preferably from 1:2 to 1:7. Since the carbon not only acts as reducing agent but also as heating element, a superstoichiometric addition is advantageous.

In the preparation of silicon halides, the preferred halogen gas is chlorine. Preference is also given to fluorine. The gaseous halogen, the gaseous hydrogen halide or the mixture thereof can be used in pure form or together with a carrier gas. As carrier gas, preference is given to inert gases selected from the group consisting of helium, nitrogen and argon and also mixtures thereof.

In a further preferred embodiment, hydrogen is added to the halogen, hydrogen halide or mixtures thereof and also, if appropriate, carrier gas, resulting in formation of halogenated silanes HₐSiX₄₋ₐ, where a is an integer from 0 to 3 and X is a halogen.

In a further embodiment of the process of the invention for preparing silicon tetrahalides, hydrogen halide gas, preferably hydrogen chloride gas (HCl), is used as gaseous halogen compound. Hydrogen fluoride (HF) can likewise be used.

In the reaction according to the invention of materials containing SiOₓ with a halogen gas (X₂) in the presence of the carbon particles or carbon-containing particles, silicon tetrahalides (SiX₄) and carbon monoxide (CO), which is in thermodynamic equilibrium with carbon dioxide (CO₂), are formed.

In the reaction according to the invention of materials containing SiOₓ with hydrogen halide in the presence of carbon or carbon-containing materials, halogenated silanes HₐSiX₄₋ₐ, where a is an integer from 0 to 3 and X is a halogen, and possibly hydrogen and carbon monoxide CO, which is in thermodynamic equilibrium with carbon dioxide CO₂, are formed.

The carbon used as heat transfer medium and, if desired, as reducing agent for preparing element halides or the corresponding carbon-containing material is preferably likewise used in particulate form, for example in the form of powder, grains, spheres or granules, in order to allow good mixing and good passage of the halogen gas or the halogen compound. The type of material used is not critical.

Pelletization or granulation of the mixture of element compound and carbon-containing material leads to particularly intimate contact between the two components and at the same time allows, owing to the porosity of the beds formed by the pellets or granules, larger flows of gas through the beds, so that higher reaction rates than in the case of mixed powders are observed. Pelletization or granulation can be carried out with addition of up to 20% of binder to the mixture of element compound and carbon-containing material. Suitable binders are carbon-containing compounds in general, for example polyvinyl alcohol, polyvinyl acetate, cellulose, starch or molasses, and also element-containing compounds.

In a further embodiment of the process of the invention, the element-containing material is added in liquid form or as gas, if appropriate at elevated temperature, to the solid carbon or carbon-containing material subjected to an electromagnetic alternating field.

In a further embodiment of the process of the invention, the carbon-containing material which can be heated by means of an electromagnetic alternating field is introduced in liquid form or as gas, if appropriate at elevated temperature, into the reaction space.

In a further embodiment of the process of the invention, at least the proportion of the carbon-containing material serving as reducing agent is introduced in liquid form or as gas, if appropriate at elevated temperature, into the reaction space. If carbon or a carbon-containing material which can be heated by means of an electromagnetic alternating field is already present in the reaction space, it is not necessary for the liquid or gaseous carbon-containing material used as reducing agent likewise to be able to be heated by means of electromagnetic alternating fields.

In a further embodiment of the process of the invention, the carbon used or the carbon-containing material used is converted within the reaction space by action of an electromagnetic alternating field, for example microwaves, on the substance mixture present in the reaction space into a form which can be heated by means of the electromagnetic alternating field.

In embodiments of the process of the invention in which the carbon or the carbon-containing material acts not only as heating element but also as reducing agent and is thus consumed during the reaction, a superstoichiometric addition is advantageous.

The treatment of the reaction mixture with an electromagnetic alternating field can lead to ignition and stabilization of a plasma in the reaction space.

The process of the invention can be carried out not only in a fixed-bed reactor as in the embodiment described but also in reactors having an agitated bed of the reaction mixture, for example with stirring of the bed, agitation of the bed by vibration or use of a fluidized-bed process. Moving-bed arrangements are particularly advantageous for continuous operation.

In the process of the invention, the energy is introduced by means of an electromagnetic alternating field, preferably microwave radiation. The power radiated in depends on the geometry of the reactor and on the amount and type of starting materials and the desired temperature. In the case of hydrolysis-sensitive element halides, temperatures above 800° C. are preferably employed.

A further advantage of the process of the invention is, in particular, that any element compounds can be used, since the introduction of microwave energy heats the carbon of the reaction mixture and enables high temperatures which could barely be achieved or achieved only with considerable thermal stressing of the reactor material by means of conventional heat sources, for example radiation heating. Likewise, the fast heating rate obtained by introduction of microwave energy is not achieved by conventional heat sources such as radiation heating. Heating by means of microwaves is thus particularly efficient.

In the process of the invention for preparing silicon tetrahalides, the introduction of energy is effected by means of an electromagnetic alternating field. Here, the energy is preferably introduced by means of microwaves, in particular microwaves having a power of 100 W or more. Particular preference is given to introducing microwave energy at 400-900 W. The power radiated in depends on the geometry of the reactor and on the amount of starting materials. It has surprisingly been found that the spark discharges observed between the carbon particles or carbon-containing particles can be initiated very quickly and vigorously and lastingly in this way. Temperatures above 800° C. are preferably employed.

The process of the invention can thus, in a preferred embodiment, surprisingly convert any SiOₓ sources into silicon halides without use of catalysts. Furthermore, the silicon tetrahalide end product obtained is preferably water-free.

The process of the invention is preferably employed for preparing element chlorides using chlorine or hydrogen chloride as reaction gases. In particular, naturally occurring materials, for example desert sand or bauxite, can be used without elaborate pretreatment in the process of the invention, so that the process of the invention is not only characterized by its versatility but also by simple handling and low costs.

In a particularly preferred embodiment, the process of the invention is employed for preparing silicon tetrachloride using Cl₂ or HCl as reaction gases. In particular, naturally occurring SiOₓ-containing materials (desert sand, etc.) can be used without elaborate pretreatment in this process according to the invention, so that the process of the invention is characterized not only by its versatility but also by simple handling and low costs.

According to the invention, it is possible to use SiOₓ sources selected from the group consisting of finely divided silica, preferably silica having a surface area of at least 50 m²/g, more preferably at least 250 m²/g, measured by the BET method, fine quartz flour, preferably quartz flour having a mean particle size of at least 0.1 μm, more preferably at least 1 μm, and preferably having a theoretical specific surface area of at least 0.1 m²/g, more preferably 0.5 m²/g, silica sand having a mean particle size of at least 0.005 mm, preferably 0.1 mm, and a theoretical specific surface area of at least 10 cm²/g, preferably 50 cm²/g, desert sand which preferably has a particle size of from 0.001 to 1 mm, bottle glass, for example soda-lime glass, preferably crushed or milled, fused silica, mica and SiO powder preferably with a particle size of from 0.01 μm to 0.1 mm.

The invention is illustrated below with the aid of industrially relevant examples. Use was made of, in particular, element-oxygen combinations which have a high element-oxygen bond enthalpy. These are shown in Table 3.

TABLE 3

| Element | Bond enthalpy [kJ/mol] |
|---|---|
| Al | 512 |
| B | 808 |
| Si | 800 |
| Ti | 672 |
| Hf | 802 |
| P | 600 |

### EXAMPLES

### Example 1

Due to the availability and heat resistance of fused silica, apparatuses and reaction supports comprising this material are used. This is not attacked under the reaction conditions. To protect the glass apparatus from reaction and thermal stress, the reactants were introduced into the reactor on fused silica supports comprising a fused silica tube which had been cut in half longitudinally and provided with feet. The reaction rate of the outer wall of the reactor is therefore significantly reduced by the low surface area and significantly lower temperature compared to powdered or granular reaction mixtures, so that destruction of the outer wall of the reactor during a single reaction was not observed.

1-1.5 g of a mixture of the materials listed with the carbon-containing materials which are likewise listed were placed on a fused silica support (halved fused silica tube, diameter 13 mm, length about 100 mm, feet of fused silica 5 mm). The fused silica support was introduced into a reaction tube (fused silica tube, diameter 30 mm, length 550 mm) which was introduced into the hot spot of a microwave reactor (MX 4000; MUEGGE Electronic GmbH). A stream of Cl₂ or HCl gas (1-5 l/min) was passed through the reaction tube while heating (550-1300° C.) by activation of the microwave reactor. Reaction products which are liquid or gaseous under normal conditions were condensed out in a cold trap in which pentane had been placed using an ethanol cold bath at less than −30° C. The reaction time was in each case about 10 minutes.

In this experimental set-up, the following element-containing compounds were reacted with carbon-containing compounds selected from the group consisting of activated carbon (high-purity, ˜2.5 mm), activated carbon (high-purity, powder), graphite (high-purity), hard coal (German hard coal) , brown coal (RWE Powers) and petroleum coke (OMV):

### Element-Containing Compounds:

Aluminum(III) oxide; <150 μm, 99%

Boron(III) oxide; high-purity, ≧99.98%

Iron(III) oxide; 5 μm, ≧99%

Hafnium(IV) oxide; 98%

Mica flakes

Silicon carbide; 37 μm

Finely divided silica (380 m²/g)

Fine quartz flour (mean particle size 3 μm, theoretical specific surface area 0.75 m²/g)

Silica sand (mean particle size 0.32 mm, theoretical specific surface area 75 cm²/g)

Desert sand; (Sahara, coordinates N23° 27.419; E 009° 01.489, particle size<0.5 mm)

Crushed brown returnable beverage bottles (brown glass)

Crushed Pasteur pipettes (soda-lime glass)

Japanese rice ash

Catalyst based on zeolite

Silicon nitride; Si₃N₄, 44 μm

Silicon monoxide; ≦44 μm

Titanium dioxide; ≧99.8%;

Tricalcium phosphate; 35-40% Ca.

Silicon tetrachloride was detected by means of GCMS and ²⁹Si NMR in comparison with purchased standard compounds.

Boron trichloride as diethyl ether adduct and phosphorus trichloride were detected by means of ¹¹B NMR and ³¹p NMR against purchased standard compounds. Iron dichloride, aluminum trichloride and hafnium tetrachloride were detected by means of EDX and X-ray powder diffraction.

Titanium tetrachloride could not be detected directly using the available laboratory equipment. The strongly fuming pentane solution was transferred to GC vials, after the precipitate formed had settled, the clear supernatant solution was taken off through the septum and introduced into a fresh vial through the septum. This clear solution was admixed with water through the septum. A voluminous white precipitate was formed immediately. This was dried and identified as titanium oxide by means of EDX.

### Example 2

1-1.5 g of an SiO₂/C mixture comprising desert sand having a maximum particle size of 0.5 mm and activated carbon having a particle size of 2-2.5 mm in a ratio of 1:4 were placed on a fused silica support (halved fused silica tube, diameter 13 mm, length about 100 mm, feet of fused silica 5 mm). The fused silica support was introduced into a reaction tube (glass tube, diameter 30 mm with two chimneys, downcomer tube plus riser tube, average spacing 100 mm) which was introduced into the hot spot of a microwave reactor (domestic Panasonic appliance). A stream of chlorine gas diluted with argon (chlorine 40 l/h, Ar 10 l/h) was passed through the reaction tube. After heating by activation of the microwave appliance, the reaction product was condensed out in a cold trap in which pentane had been placed using an ethanol cold bath at less than −30° C.

Quantitative and qualitative -analysis was carried out. The reaction product obtained is SiCl₄.

50-60% of the desert sand were reacted in a reaction time of 15-20 minutes, with the calculation being carried out on the basis of the weight difference of the sample after the reaction SiO₂+2 C+2 Cl₂→SiCl₄+2 CO. The experiment was stopped when no further decrease in mass was observed after irradiation for a further 5 minutes. Taking into account the SiO₂ content of about 80% in the sand used and the influence of the Boudouard equilibrium with formation of CO₂ and C from CO, the actual SiO₂ conversion increases correspondingly. A largely quantitative yield based on the SiOₓ source could therefore be obtained.

### Example 3

A mixture of hydrogen chloride (60 l/h) and nitrogen (40 l/h) was passed through the experimental set-up described in Example 1. 50-60% of the desert sand were reacted in a reaction time of 15-20 minutes, with the calculation being carried out on the basis of the weight difference of the sample after the reaction SiO₂+2 C+2 Cl₂→SiCl₄+2 CO. The experiment was stopped when no further decrease in mass was observed after irradiation for a further 5 minutes. Taking into account the SiO₂ content of about 80% in the sand and the influence of the Boudouard equilibrium with formation of CO₂ and C from CO, the actual SiO₂ conversion increases correspondingly. A virtually quantitative yield based on the SiOₓ source could therefore be obtained.

### Example 4

A mixture of hydrogen chloride (20 l/h) and hydrogen (20 l/h) is passed through the experimental set-up described in Example 1. The product isolated contains SiCl₄ together with HSiCl₃.

1.-25. (canceled)

26. A process for preparing element halides, comprising:
contacting a mixture of a material containing the element with carbon or a carbon-containing material, with a gas stream containing halogen which is gaseous under the reaction conditions or a gaseous halogen compound or mixture thereof, while heating by means of an electromagnetic alternating field.

27. The process of claim 26, wherein the materials containing the respective element are supplied in pulverulent form.

28. The process of claim 26, wherein carbon of the carbon-containing material is present in granular form or powder form.

29. The process of claim 26, wherein the element-containing material is introduced into the reaction space in liquid form or as gas.

30. The process of claim 26, wherein the carbon-containing material is introduced into the reaction space in liquid form or as gas.

31. The process of claim 26, wherein the electromagnetic alternating field used is generated by means of microwave radiation.

32. The process of claim 26, wherein the carbon or the carbon-containing material is heated by means of the electromagnetic alternating field.

33. The process of claim 26, wherein the carbon or carbon-containing material is converted by action of an electromagnetic alternating field on the substance mixture present in the reaction space into a form which can be heated by means of the electromagnetic alternating field.

34. The process of claim 26, wherein the halogen which is gaseous under reaction conditions, the gaseous halogen compound or the mixture thereof is used together with a carrier gas.

35. The process of claim 26, wherein fluorine-containing or chlorine-containing compounds are used as halogen-containing compounds.

36. The process of claim 26, wherein chlorine is used as gaseous halogen or hydrogen chloride is used as gaseous halogen compound.

37. The process of claim 26, wherein the element present in the element compound used is a nonmetal.

38. The process of claim 26, wherein the compound containing the element is present in admixture with further materials.

39. The process of claim 26, wherein the carbon or the carbon-containing material is converted at least partly into carbon compounds which cannot be excited by the electromagnetic alternating field during the production of the element halide.

40. The process of claim 26, wherein the mixture is heated to a temperature of at least about 7000C during the preparation of a hydrolysis-sensitive element halide.

41. The process of claim 26, wherein a naturally occurring raw material is used as element-containing material.

42. The process of claim 26, wherein a by-product or waste product of an industrial production process is used as a material containing the element.

43. The process of claim 26, wherein the element-containing material is subjected to purification steps or steps to increase the concentration of the element before it is used in the process.

44. The process of claim 26, wherein materials containing SiOₓ, where x can be from 1 to 2, are used as element-containing material(s).

45. The process of claim 44, wherein microwave energy at from 100 to 900 W is introduced.

46. The process of claim 44, wherein hydrogen is additionally fed into the reaction gas.

47. The process of claim 44, wherein hydrogen chloride is used as a gaseous halogen compound.

48. The process of claim 44, wherein desert sand is used as silicon oxide source.
